(19) United States
(12) Patent Application Publication
(10) Pub. No.: US 2014/0114826 A1
(43) Pub. Date: Apr. 24, 2014

(54) METHOD AND SYSTEM FOR FINANCIAL TRANSACTION PROCESSING

(71) Applicant: Fusebill Inc, Kanata (CA)

(72) Inventors: Carlos Lopez, Ottawa (CA); Serge Frigon, Russell (CA)

(73) Assignee: Fusebill Inc, Kanata (CA)

(21) Appl. No.: 14/050,543

(22) Filed: Oct. 10, 2013

Related U.S. Application Data
(60) Provisional application No. 61/715,915, filed on Oct. 19, 2012.

(51) Int. Cl. G06Q 30/04

(52) U.S. Cl. CPC G06Q 30/04
USPC 705/34

(57) ABSTRACT

Large volumes of financial transactions are processed today across a variety of financial platforms including but not limited to debit cards, credit cards, prepaid cards, e-purse, Automatic Teller Machine (ATM) transactions, and Point of Sale (POS) cards. It would be beneficial if financial transaction software systems and/or software applications supported discrete and periodic transactions wherein the timescales of transactions may be established with high flexibility. It would be further of benefit if the financial system provided increased security such that customer specific financial data is stored within a trusted platform wherein external databases identifying a customer cannot be linked directly to that within the trusted platform. Further it would beneficial for such a system to exploit an encryption key pool such that an encryption key employed was only identified through a unique identity and that said encryption keys within the pool may be expired with arbitrary policies.

### CROSS-REFERENCE TO RELATED APPLICATIONS

This patent application claims the benefit of U.S. Provisional Patent Application 61/715,915 filed on Oct. 19, 2012 entitled “Method and System for Financial Transaction Processing.”

### FIELD OF THE INVENTION

The present invention relates to financial transactions and more particularly to automated periodic processing of financial transactions.

### BACKGROUND OF THE INVENTION

A financial transaction is an agreement, communication, or movement carried out between a buyer and a seller to exchange an asset or provide a service in response to or prior to an exchange of payment from the buyer to the seller. It involves a change in the status of the finances of two or more businesses or individuals as a result. The buyer and seller are separate entities or objects, often involving the exchange of items of value, such as information, goods, services, and money.

One particular form of financial transaction is the subscription and its associated subscription business model wherein a customer must pay a subscription price to have access to the product/service. The model was pioneered by magazines and newspapers, but is now used by many businesses and websites. Rather than selling products individually, a subscription sells periodic (monthly or yearly or seasonal) use or access to a product or service, or, it may sell for example all tickets to the entire season of a sports franchise wherein the season is only part of a calendar year. Thus, a one-time sale of a product can become a recurring sale and can build brand loyalty and can be used for anything where a user is tracked in both a subscribed and unsubscribed status.

Industries that use this model include, but are not limited to, mail order clubs, cable television, satellite television providers, pay-TV channels, satellite radio, telephone companies, cell phone companies, Internet providers, software providers, business solutions providers, financial services firms, fitness clubs, and pharmaceuticals, as well as the traditional newspapers, magazines and academic journals. Utilities may also be subscription based with equipment rentals as well as consumption based charging. Renewal of a subscription may be periodic and activated automatically, so that the cost of a new period is automatically paid for by a pre-authorized charge to a credit card or a checking account. In the U.S., recurring card charges must be disclosed in writing to the cardholder at least 10 days before each charge. An alternative model common today with the Internet and web sites is what is commonly referred to as a “freemium” model wherein content may be provided free, but access to premium features, e.g. archives, full content of articles, etc., is limited to paying subscribers.

In 2008 the total value of financial transactions has been estimated as $2,200,000 billions dollars of which approximately 95% related to financial market activities. Even at just 5% the total value of commercial business transactions is approximately $110,000 billion. Further, given that an average credit card transaction in 2009 was $100 and that average debit card transactions have been reducing such that in 2010 a quarter of all debit card transactions were less than $10 it is evident that a massive number of financial transactions must be processed annually.

Accordingly it would be beneficial to provide a financial transaction software system and/or software application supporting processing of financial transactions across a variety of financial platforms including but not limited to debit cards, credit cards, prepaid cards, e-purse, Automatic Teller Machine (ATM) transactions, and Point of Sale (POS) cards. Further it would be beneficial if the financial transaction software system and/or software application supported discrete and periodic transactions wherein the timescales of transactions may be established with increased flexibility over existing prior art billing systems which are driven by predetermined policies of the enterprise overall. For example an electrical utility executes billing monthly and runs their processing on a predetermined day each month for a customer based upon a sequence of the utility rather than other characteristics such as the date the customer registered with the utility or a customer preference to be billed bi-monthly and 2 days after their bi-monthly salary is deposited into their account.

Further, it would be beneficial to implement a financial transaction software system and/or software application which provides increased security such that customer specific financial data, including for example credit card data, is stored within a trusted platform wherein external databases identifying a customer cannot be linked directly to that within the trusted platform. It would also be beneficial for such a system to exploit a pool of encryption keys and that the encryption key employed to encrypt data being transmitted from the external world to the trusted platform was only identified through a unique identity such that interception of encrypted messages did not result in exposure of financial data. Further, it would be beneficial if the encryption keys were pooled and may be expired with arbitrary policies including number of uses for example rather than simply an expiry time.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations in the prior art relating to financial transactions and more particularly to automated periodic processing of financial transactions.

In accordance with an embodiment of the invention there is provided a method comprising:
storing subscriber data within a database forming a predetermined portion of a trusted platform connected to a network, the subscriber data relating to a plurality of subscribers and comprising for each subscriber of the plurality of subscribers at least a financial instrument, a subscription duration type, a subscription frequency, and a next renewal time;
executing upon a process controller connected to the network and comprising at least a microprocessor a billing process, the billing process relating to a plurality of subscribers for whom subscriber data is stored upon the database;
determining for each subscriber of the plurality of subscribers whether a subscription billing event is due in dependence upon at least the current time and the next renewal time;
calculating a new next renewal time for each subscriber of the plurality of subscribers when the determination is positive, the new next renewal time calculated in dependence upon at least the subscription duration type and subscription frequency of the subscriber of the plurality of subscribers; and
storing for each subscriber of the plurality of subscribers when the determination is positive the new next renewal time within the subscriber database.

In accordance with an embodiment of the invention there is provided a device comprising:
a memory for storing subscriber data within a database forming a predetermined portion of a trusted platform connected to a network, the subscriber data relating to a plurality of subscribers and comprising for each subscriber of the plurality of subscribers at least a financial instrument, a subscription duration type, a subscription frequency, and a next renewal time; and
a process controller connected to the network and comprising at least a microprocessor, the process controller storing within a non-volatile non-transitory memory instructions for a process for execution by the processor, the process comprising the steps of:
   executing a billing process, the billing process relating to a predetermined subset of the plurality of subscribers for whom subscriber data is stored upon the database;
   determining for each subscriber of the plurality of subscribers whether a subscription billing event is due in dependence upon at least the current time and the next renewal time;
   calculating a new next renewal time for each subscriber of the plurality of subscribers when the determination is positive, the new next renewal time calculated in dependence upon at least the subscription duration type and subscription frequency of the subscriber of the plurality of subscribers; and
   storing for each subscriber of the plurality of subscribers when the determination is positive the new next renewal time within the subscriber database.

In accordance with an embodiment of the invention there is provided a method comprising:
i) receiving at an application interface in execution upon a first computer comprising at least a microprocessor a request from an external source, the request relating to a customer of the external source;
ii) transmitting from the first computer to a second computer comprising at least a microprocessor a polling request relating to a list of process controllers able to service the request;
iii) determining a process controller from the list of process controllers provided by the second computer to the first computer in response to the polling request;
iv) transmitting from the first computer via the second computer a process request to the determined process controller, the process request comprising at least a predetermined portion of the request encrypted with an encryption key, a unique key identifier identifying the encryption key employed, and a unique identifier identifying the process request;
v) processing the process request with the determined process controller;
vi) transmitting a processed request response to the second computer, the processed request response comprising at least the unique identifier identifying the process request and processed request data generated in dependence upon the predetermined portion of the request and the process performed by the determined process controller;
vii) storing the processed request response in the intermediate database.

In accordance with an embodiment of the invention there is provided a method comprising:

providing a trusted platform in execution upon a first computer comprising at least a microprocessor, the trusted platform providing:
generation of an encryption key;
generation of a unique identity for the encryption key, the unique identity generated in dependence upon an encryption of the encryption key with a pair of master keys;
transmission of the encryption key and its associated unique identity to a remote computer comprising at least a microprocessor;
decryption of data received from the remote computer encrypted with the encryption key wherein the data is received without the encryption key but is received with the unique identity; and
encryption of the data received from the remote computer with the two master keys for storage within a memory associated with the trusted platform.

In accordance with an embodiment of the invention there is provided a system comprising:
a plurality of first computers, each first computer connected to a network and comprising at least a microprocessor and for receiving at an application interface in execution upon the first computer a request from an external source, the request relating to a customer of the external source;
a plurality of second computers, each second computer connected to a network and comprising at least a microprocessor for:
   receiving a polling request from a first computer of the plurality of first computer, the polling request relating to a list of process controllers able to service the request;
   determining the list of process controllers in dependence upon data communicated to the second computer by each process controller of a plurality of process controllers, the data relating to the processes supported by the process controller;
   transmitting from the second computer to the first computer the list of process controllers; and
the plurality of process controllers, each process controller connected to the network and for executing at least a predetermined process upon request data provided by a first computer associated with a request received by the first computer.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a telecommunications network supporting communications to and from electronic devices and servers implementing financial transactions according to embodiments of the invention;

FIG. 2A depicts a schematic system architecture for a system implementing financial transactions according to embodiments of the invention;

FIG. 2B depicts an exemplary process flow for a system implementing financial transactions according to embodiments of the invention receiving credit card data and storing it securely within a protected environment;

FIG. 3A depicts a schematic of the system architecture implementing financial transactions according to embodiments of the invention as depicted in FIG. 2 with scaling determined in dependence of the financial transaction activities undertaken with the system architecture;

FIG. 3B depicts an exemplary process flow indicating the load balancing, polling and a firewalled anti-hacking aspects of a system implementing financial transactions according to embodiments of the invention;

FIG. 4 depicts an exemplary process flow for processing a batch of subscriptions according to an embodiment of the invention.

### DETAILED DESCRIPTION

The present invention is directed to financial transactions and more particularly to automated periodic processing of financial transactions.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communication that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader. A “fixed electronic device” (FED) as used herein and throughout this disclosure, refers to a device used for communication that is dependent upon a connection to a connection to an electrical mains or other form of distributed energy for power. This includes devices, but is not limited to, such as a desktop computer, television, gaming console, kiosk, and a terminal.

A “network operator/service provider” as used herein may refer to, but is not limited to, a telephone or other company that provides services for mobile phone subscribers including voice, text, and Internet; telephone or other company that provides services for subscribers including but not limited to voice, text, Voice-over-IP, and Internet; a telephone, cable or other company that provides wireless access to local area, metropolitan area, and long-haul networks for data, text, Internet, and other traffic or communication sessions; etc.

A “wares provider” and/or “service provider” as used herein and through this disclosure refers to, but is not limited to, a provider of wares (goods/products) and/or services (direct/indirect) to a user or on behalf of a user. This includes, but is not limited to, retailers, stores, shops, utilities, network operators, service providers, and charities. A “subscription” as used herein and through this disclosure refers to, but is not limited to, a financial transaction. This includes, but is not limited to, annual contracts, fixed term contracts, pay-per-use activities, etc. A purchase may be considered within embodiments of the invention as a subscription with a single occurrence.

A “financial registry” as used herein and through this disclosure refers to, but is not limited to, a database of customer and/or subscriber information relating to finances including, but not limited to, financial instruments such as credit cards, debit cards, and gift cards for example; financial services such as loans, mortgages, and banking for example; and financial accounts such as those relating to checking, savings, mortgage, line of credit, shares, and Government regulated savings. A “user,” as used herein and through this disclosure refers to, but is not limited to, a person or device that utilizes the financial registry, either as a provider of a product, ware, and/or service, controller of the financial registry, a financial provider of a financial product and/or service, or as a client of a product, ware, and/or service provider. A “registered party” as used herein may refer to a person, group, or organization that has registered with a financial registry and may or may not be the intended recipient of monies or intended provider of monies associated with a financial transaction. A “financial provider” as used herein may refer to any provider of financial services, either online and/or in a traditional physical location including, but not limited to, credit, debit, and loan services against which financial charges are made arising from periodic and/or aperiodic transactions relating to a user and/or registered party.

A “financial registry” as used herein and through this disclosure refers to, but is not limited to, a database of customer and/or subscriber information relating to finances including, but not limited to, financial instruments such as credit cards, debit cards, and gift cards for example; financial services such as loans, mortgages, and banking for example; and financial accounts such as those relating to checking, savings, mortgage, line of credit, shares, and Government regulated savings. A “user,” as used herein and through this disclosure refers to, but is not limited to, a person or device that utilizes the financial registry, either as a provider of a product, ware, and/or service, controller of the financial registry, a financial provider of a financial product and/or service, or as a client of a product, ware, and/or service provider. A “registered party” as used herein may refer to a person, group, or organization that has registered with a financial registry and may or may not be the intended recipient of monies or intended provider of monies associated with a financial transaction. A “financial provider” as used herein may refer to any provider of financial services, either online and/or in a traditional physical location including, but not limited to, credit, debit, and loan services against which financial charges are made arising from periodic and/or aperiodic transactions relating to a user and/or registered party.

An “External World” as used herein and through this disclosure refers to an environment within which a transaction between a user and a wares provider and/or service provider is executed resulting in a financial commitment between the user and the wares provider and/or service provider on a discrete and/or recurring basis with respect to the provisioning of at least one of a ware, wares, goods, a good, a product, products, a service, and services to the user by the wares provider and/or service provider. Accordingly, the “External World” includes, but is not limited to, servers, systems, and equipment relating to at least one of the wares provider(s), service provider(s), and financial provider(s) storing and managing aspects of the associated provider including, but not limited to, financial registries, service registries, user registries, security registries, credential registries, user registries, service agreements, service level agreements, and contracts. The “External World” may also include, but is not limited to, systems and equipment relating to the user including, but not limited to, PED(s) and FED(s) to which wares and/or services are provided.

A “software system” as used herein and through this disclosure refers to a computer, server, or other microprocessor based device either alone or in combination with other microprocessor based devices communicating with one another via at least one telecommunications protocol to support one or more software applications providing one or more functions associated with the financial registry including those for users, registered parties, financial providers, and others accessing the financial registry. A “software application” as used herein and through this disclosure refers to a set of programs, procedures, algorithms and associated documentation concerned with the operation of a data processing system according to embodiments of the invention relating to providing one or more functions associated with the financial registry including those for users, registered parties, financial providers, and others accessing the financial registry.

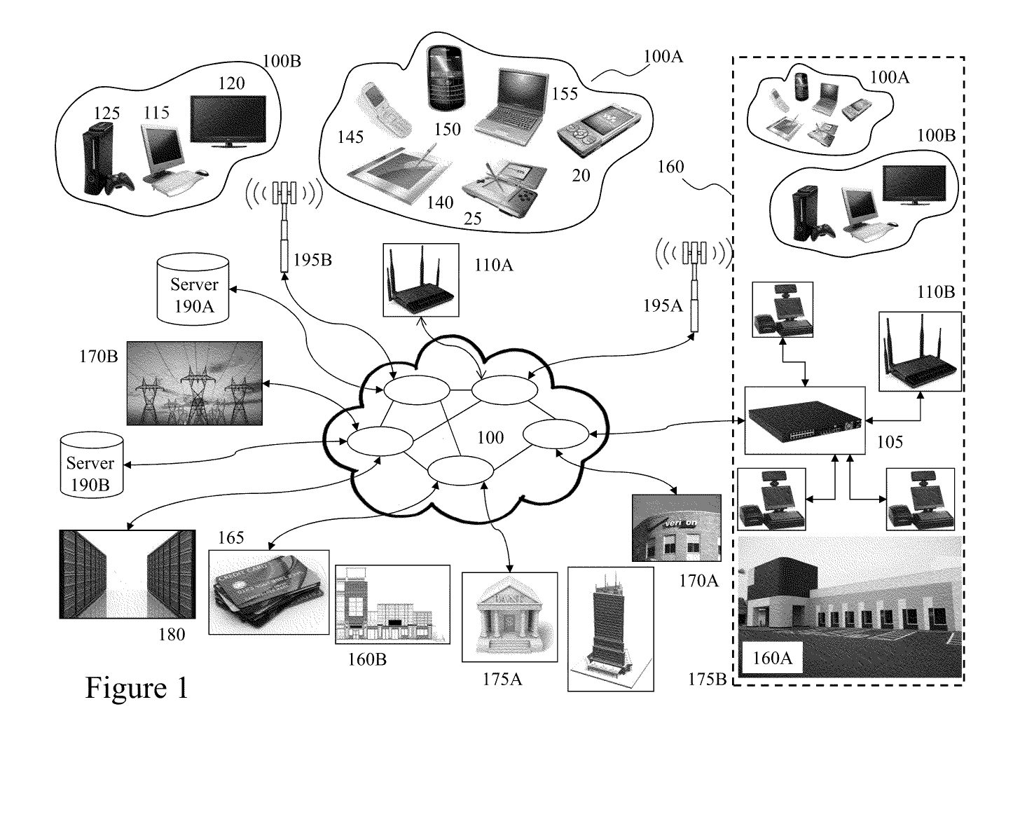

Now referring to FIG. 1 there is depicted a telecommunications network 100 supporting communications to and from electronic devices providing information relating to financial transactions to be processed with a financial software system according to embodiments of the invention as described below in respect of the other figures. As shown first and second user groups 100A and 100B respectively interface to a telecommunications network 100, each of the first and second user groups 100A and 100B representing portable electronic devices (PEDs) and fixed electronic devices (FEDs) respectively which may according to embodiments of the invention be sources of transactions requiring processing through a financial software system according to an embodiment of the invention or processing one or more financial instruments thereby providing alternate data to be processed by a financial software system according to an embodiment of the invention. Within the representative telecommunication architecture a remote central exchange 180 communicates with the remainder of a telecommunication service provider's network via the telecommunications network 100 which may include for example long-haul OC-48/OC-192 backbone elements, an OC-48 wide area network (WAN), a Passive Optical Network, and a Wireless Link. The central exchange 180 is connected via the telecommunications network 100 to local, regional, and international exchanges (not shown for clarity) and therein through telecommunications network 100 to first and second wireless access points (AP) 195A and 195B respectively which provide Wi-Fi cells for first and second user groups 100A and 100B respectively. Also connected to the telecommunications network 100 are first and second Wi-Fi nodes 110A and 110B, the latter of which being coupled to telecommunications network 100 via router 105. Second Wi-Fi node 110B is associated with first commercial building 160A and environment 160 within which are first and second user groups 100A and 100B. First commercial building 160A for example may be a retailer's retail location, a shopping centre, a restaurant, a market or another location wherein a user and provider of wares/services may engage as two parties of a transaction committing a discrete or recurring financial commitment from the user to the provider of a ware, wares, service, or services. Second user group 100B may also be connected to the telecommunications network 100 via a wired interface examples of which include, but are not limited to, DSL, Dial-Up, DOCSIS, Ethernet, G.hn, ISDN, MoCA, PON, and Power line communication (PLC) which may or may not be routed through a router such as router 105.

Within the cell associated with first Wi-Fi node 110A the first group of users 100A may employ a variety of PEDs including for example, laptop computer 155, portable gaming console 135, tablet computer 140, smartphone 150, cellular telephone 145 as well as portable multimedia player 130. Within the cell associated with second Wi-Fi node 110B are the second group of users 100B which may employ a variety of FEDs including for example, gaming console 125, personal computer 115 and wireless/Internet enabled television 120 as well as cable modem 105.

Also connected to the telecommunications network 100 are first and second APs 195A and 195B respectively which provide, for example, cellular GSM (Global System for Mobile Communications) telephony services as well as 3G and 4G evolved services with enhanced data transport support. Second AP 195B provides coverage in the exemplary embodiment to first and second user groups 100A and 100B. Alternatively the first and second user groups 100A and 100B may be geographically disparate and access the telecommunications network 100 through multiple APs, not shown for clarity, distributed geographically by the network operator or operators. First AP 195A as show provides coverage to first user group 100A and environment 160, which comprises second user group 100B as well as first user group 100A. Accordingly, the first and second user groups 100A and 100B may according to their particular communications interfaces communicate to the telecommunications network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-2000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly portable electronic devices within first user group 100A may form associations either through standards such as IEEE 802.15 and Bluetooth as well in an ad-hoc manner.

Also connected to the telecommunications network 100 are financial clearing house 165, second commercial environment 160B, service provider 170A, utility provider 170B, and first and second financial providers 175A and 175B respectively. Accordingly, users within first and second commercial environments 160A and 160B may trigger requests for financial transactions from a financial institution, such as first or second financial providers 175A and 175B respectively, as a result of an activity such as a purchase of an item and/or service. These financial transactions may be undertaken directly with the respective one of the first and second financial providers 175A and 175B respectively or brokered through financial clearing house 165. The user may also trigger aperiodic recurring financial transactions as the result of activities with a service provider 170A and periodic recurring financial transactions such as those triggered with utility provider 170B.

As depicted in FIG. 1 the first commercial environment 160A is depicted as being linked to telecommunications network 100 with a wired interface via router 105. In many instances each of the financial clearing house 165, second commercial environment 160B, service provider 170A, utility provider 170B, and first and second financial providers 175A and 175B respectively will be similarly interfaced to the telecommunications network 100 via wired interfaces. However, in other instances a user may be undertaking a purchase from a provider of a service and/or wares directly an electronic device such as a PED wherein they form part of first user group 100A with wireless interfaces or a FED wherein they form part of second user group 100B with wired interfaces. In other instances the user may, for example, trigger a financial transaction using their PED with a provider using a PED or with a credit/debit card with a point-of-sale terminal interfaced directly to a PED such as those provided by Square (www.squareup.com).

In many instances periodic and aperiodic transactions arise based upon an entity, such as the service provider 170A and/or utility provider 170B executing a billing process to a user which then results in a financial transaction being made against a financial instrument of the user. Such a financial instrument may include, but not be limited to, a bank account, a credit account, and a debit account. In other instances the transactions arise from activities of the user including, but not limited to, making a purchase of a ware, making a purchase of a service, making a reservation relating to a ware, making a reservation relating to a service, making a donation, and sending a financial gift.

According to embodiments of the invention the processing of periodic and aperiodic financial transactions may be handled through an intermediate financial brokering service, such as provided for example by the Applicant rather than directly by the provider of the wares/services associated with the periodic and aperiodic financial transactions thereby offloading infrastructure requirements from the provider of the wares/services to the intermediate financial brokering service. Accordingly, intermediate financial brokering service operates first and second servers 190A and 190B which together with others not shown for clarity, may host according to embodiments of the inventions multiple services associated with a provider of the intermediate financial brokering service including, but not limited to, software operating system(s) and/or software application(s) associated with establishment, maintenance, and execution of periodic and aperiodic financial transactions relating to either a user or a provider of wares and/or services. First and second servers 190A and 190B respectively may also include additional elements including, but not limited to, product databases, inventory management databases, retail pricing databases, license databases, customer databases, websites, and software applications for download to or access by fixed and portable electronic devices. First and second primary content sources 190A and 190B may also host, for example, other services, including, but not limited to, Internet services such as a search engine, third party applications, other Internet based services, communications services, reporting services, and management services.

It would be evident that communications between many elements including, but not limited to first commercial environment 160A, second commercial environment 160B, service provider 170A, utility provider 170B, first and second financial providers 175A and 175B respectively, and first and second user groups 100A and 100B in communicating to/from the network 100 and other aspects of the network may employ one or more of the known transport level encryption methods within the prior art. For example this may be Transport Level Security (TLS) or Secure Sockets Level (SSL) encryption wrapped by GSM mobile stream encoding such as A5/3.

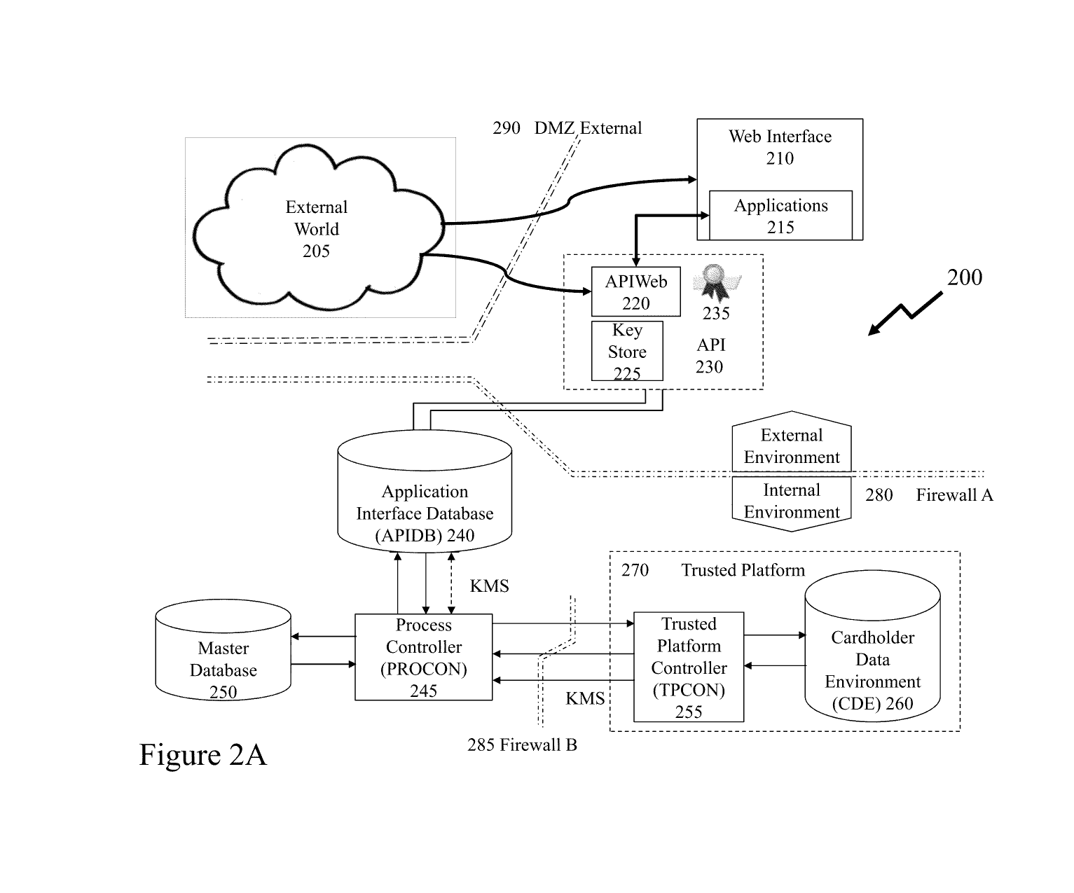

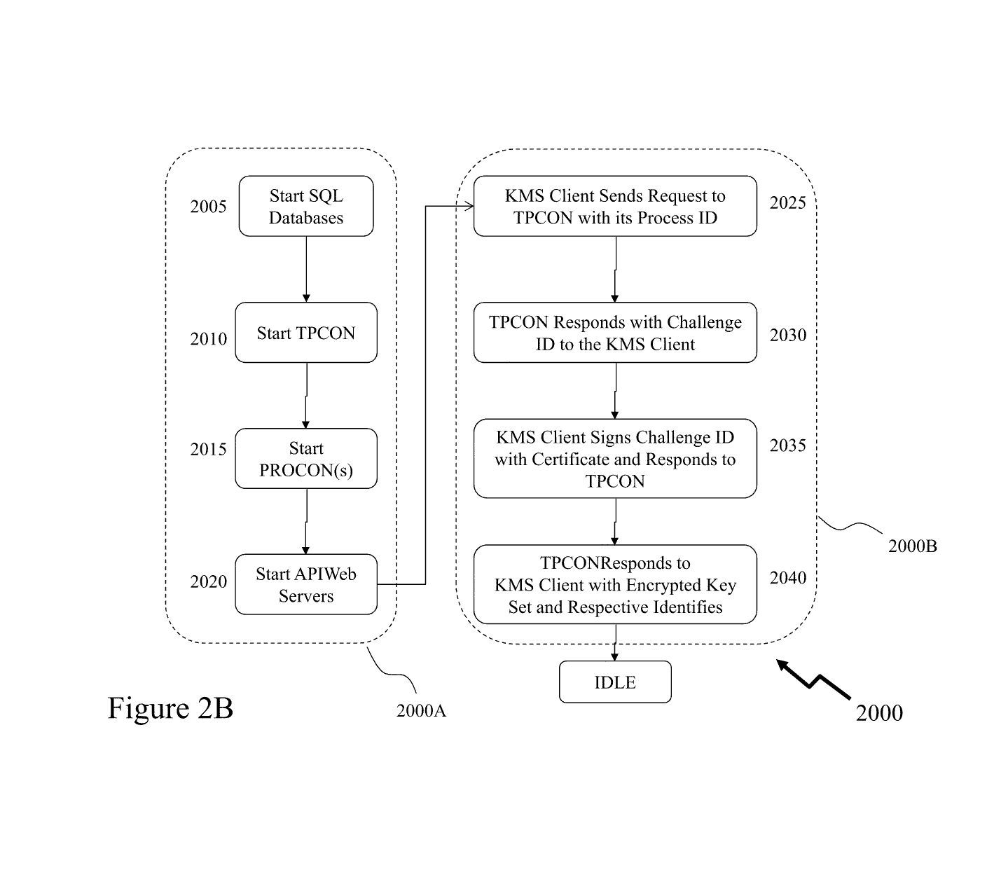

Now referring to FIG. 2A there is depicted schematic system architecture 200 for a system implementing financial transactions according to embodiments of the invention. As depicted external third parties, represented by External World 205, may engage the Application Interface 230 of the system architecture 200 indirectly via a web based user interface, represented by Web Interface 210, or for those clients with client interfaces directly via Web based Application Interface (APIWeb) 220. Users engaging via Web Interface 210 access one or more software applications, denoted by Applications 215, which then communicate to the APIWeb 220 within the API 230. Also within API 230 is a Key Store 225 as well as any digital security certificates, represented by Certificate 235.

API 230 communicates to a remote database, Application Interface Database (APIDB) 240, which is behind a first firewall, Firewall A 280. The APIDB 240 acts as a request/response server to the API 230 via requests which are forwarded from the API Database 240 to a Process Controller (PROCON) 245 and responses received from the Process Controller (PROCON) 245. APIDB 240 and PROCON 245 also communicate security key information forming part of the overall Key Management System (KMS) but via a separate channel to the requests and responses although the security information is transmitted to the API 230 over the same channel as the other information transmitted from the APIDB 240 to the API 230. The PROCON 245 communicates with Master Database 250 as well as with Trusted Platform Controller (TPCON) 255 which forms part of Trusted Platform 270. Requests to and from PROCON 245 to TPCON 255 are parsed by a second firewall, Firewall B 285. Additionally, the PROCON 245 and TPCON 255 may communicate via a separate channel information relating to the overall Key Management System (KMS). The TPCON 255 itself also communicates to Cardholder Data Environment (CDE) 260 within the Trusted Platform 270.

It would be evident that communications between elements including, but not limited to External World 205, Application Interface 230, Web Interface 210, and APIWeb 220, in communicating to/from each other may employ one or more of the known transport level encryption methods within the prior art. For example this may be Transport Level Security (TLS) or Secure Sockets Level (SSL) encryption wrapped by GSM mobile stream encoding such as A5/3. Additionally, as depicted between the External World 205 and the Application Interface 230, Web Interface 210, and APIWeb 220 is a firewall demarcation zone (DMZ), DMZ External 290. Accordingly it would be evident that DMZ External 290 represents a conventional firewall as may exist using solutions known within the prior art and that Firewall A 280 and Firewall B 285 represent additional firewalls according to embodiments of the invention and do not replace firewalls/DMZs that would otherwise exist.

Now referring to FIG. 2B there is depicted an exemplary process flow 2000 for a system implementing financial transactions according to embodiments of the invention receiving credit card data and storing it securely within a protected environment. Process flow 2000 depicted represents a KMS initialization sequence which can occur at any point during execution of financial transaction systems according to embodiments of the invention employing elements of the system such as described above in respect of FIG. 2A.

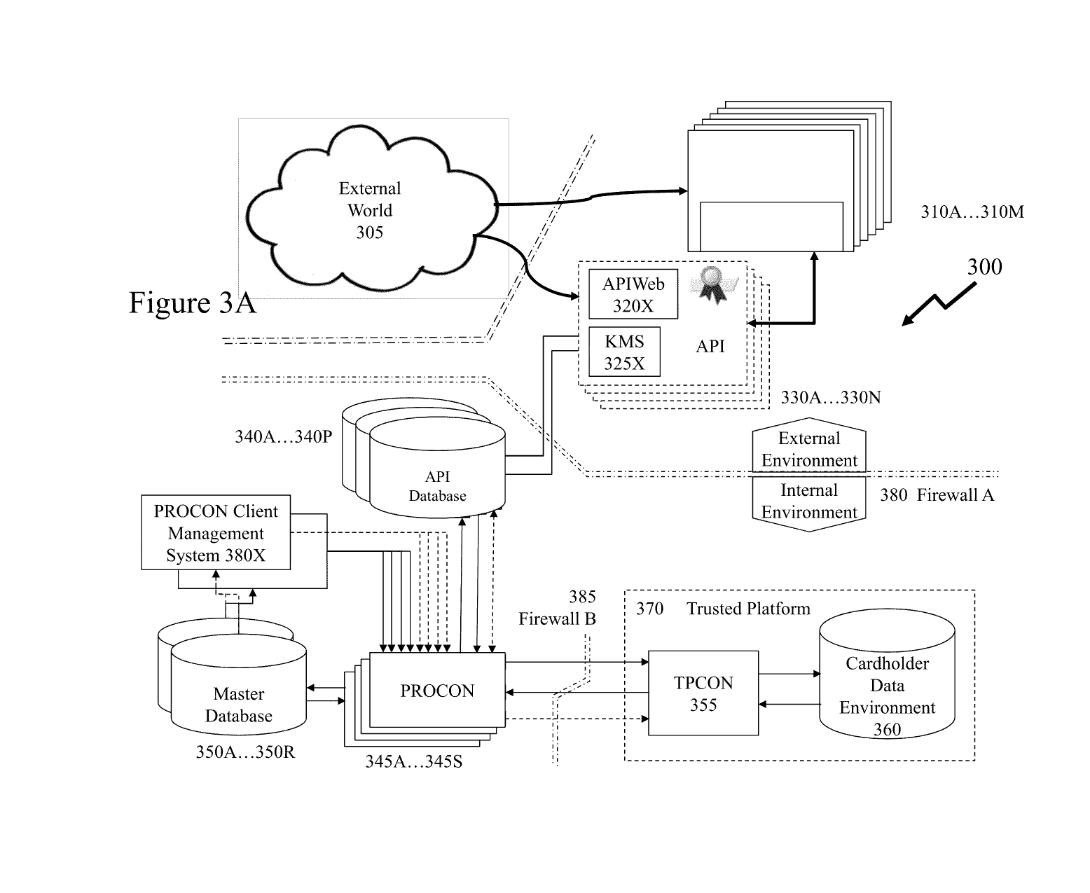

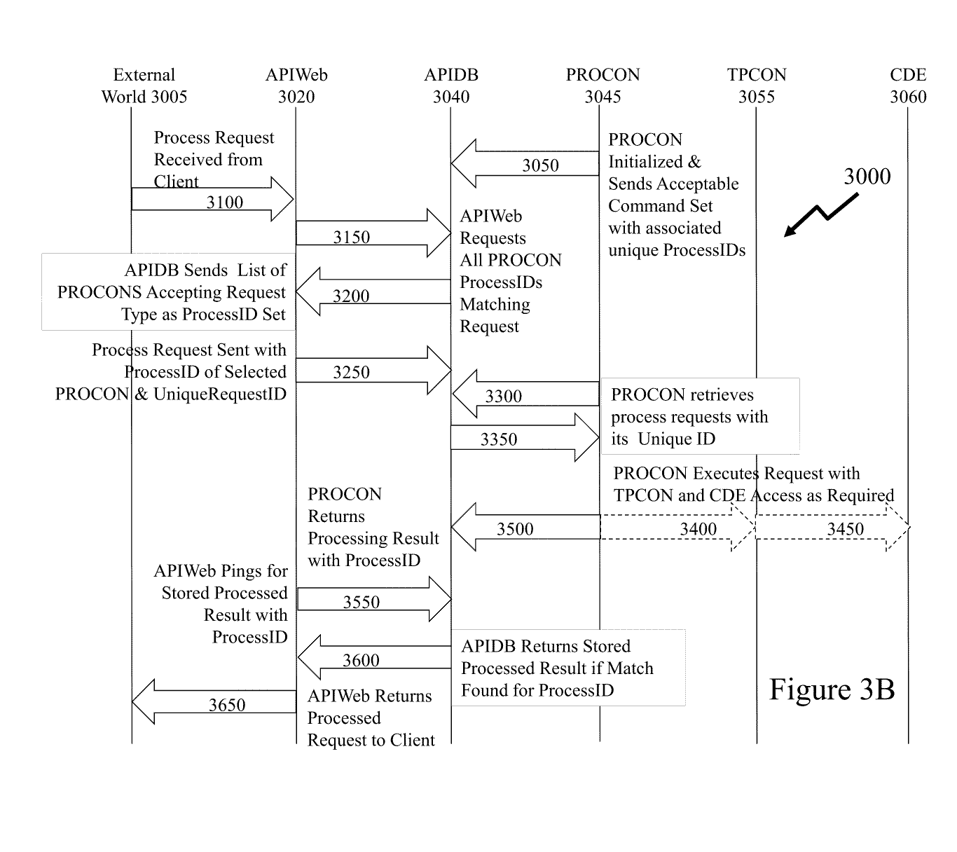

As depicted process flow 2000 is depicted as comprising system element initialization flow 2000A and key initialization flow 2000B. System element initialization flow 2000A comprises the following elements:
Step 2005—Start all SQL Databases;
Step 2010—Start TPCON 255 which will create the KMS key sets and unlock the credit card vault CDE 260;
Step 2015—Start PROCON(s) 245 which will flush the queues and cause the PROCONs 245 to “sign up for work” such as described below in respect of process step 3050 in FIG. 3B; and
Step 2020—Start APIWeb Servers 220 and Web Interfaces 230 to provide the client interfaces and KMS Clients (Key Store 225) service wherein the KMS Clients services will pre-fetch KMS keys at this point and prepare for requests.

Key initialization flow 2000B comprises the following elements:
Step 2025—KMS Client (Key Store 225) sends a request to a TPCON 245 with its ProcessID(s) that tie instances of specific software processes to a physical hardware/firmware device;
Step 2030—TPCON 245 responds with a challenge ID to the KMS Client;
Step 2035—KMS Client signs the challenge ID with its Certificate 235 and responds to the TPCON 245;
Step 2040—TPCON 245 responds to a valid Certificate 235 received in association with the challenge ID from the KMS Client with an encrypted set of keys and respective IDs; and
Step 2045—wherein the system is initialized and awaits receipt of incoming processing requests from the External World 205.

Process flow 2000 as depicted comprising system element initialization flow 2000A and key initialization flow 2000B may be established at any time either with an existing operational system or through the addition of additional elements. It is within the embodiments of the invention described supra and below bound to a particular transaction but it would be evident that the system element initialization flow 2000A and/or key initialization flow 2000B may be established under predetermined trigger conditions

It would be evident that other key management systems may be implemented that employ a separate channel for KMS communications including those using asymmetric key algorithms as well as symmetric key algorithms. For example key set generation may be transferred from the Trusted Platform comprising TPCON and CDE to the APIWeb devices such that a cracking of one APIWeb device's key generation process impacts those active transactions being processed by that APIWeb rather than all current transactions from the Trusted Platform. In other embodiments of the invention the communications relating to KMS communications may be exchanged using the same channel as the communications between APIDB, PROCON, and TPCON. Likewise APIWeb to APIDB communications may exploit a separate KMS channel.

Now referring to FIG. 3A there is depicted a schematic system architecture 300 for a system implementing financial transactions according to embodiments of the invention. As depicted external third parties, represented by External World 305, may engage of the Application Interfaces 330A through 330N respectively of the system architecture 300 indirectly via a web based user interface, represented by Web Interfaces 310A through 310M respectively, or for those clients with client interfaces directly via a Web based Application Interface (APIWeb) 320X, where X=A, . . . , N, of the associated Application Interface 330A through 330N respectively. Users engaging via one of the Web Interfaces 310A through 310M respectively access one or more software applications which then communicate to the APIWeb 320X within the associated API 330A through 330N respectively. Also within each API interface 330A through 330N respectively is a Key Store 325X as well as any digital security certificates, represented by Certificate.

Each API 330A through 330N respectively communicates to one of the P remote databases, Application Interface Database (APIDB) 340A through 340P respectively, which are behind a first firewall, Firewall A 380X. Each APIDB 340A through 340P respectively acts as a request/response server to a subset of the APIs 330A through 330N respectively via requests which are forwarded from the APIDBs 340A through 340P respectively to one or more Process Controllers (PROCONs) 345A through 345S respectively and responses received from the Process Controllers (PROCONs) 345A through 345S respectively. APIDBs 340A through 340P respectively and PROCONs 345A through 345S respectively also communicate security key information forming part of the overall Key Management System (KMS) but via separate channels to the requests and responses although the security information is transmitted to the APIs 330A through 330N respectively over the same channel as the other information transmitted from the APIDBs 340A through 340P respectively to the APIs 330A through 330N respectively. The PROCONs 345A through 345S respectively also communicate with a plurality of Master Databases 350A through 350R respectively as well as with the Trusted Platform Controller (TPCON) 355 which forms part of Trusted Platform 370. The PROCONs 345A through 345S respectively are also all connected to a PROCON Client Management System 380X that allows for overall control of the PROCON activities.

Requests to and from the PROCONs 345A through 345S respectively to TPCON 355 are parsed by a second firewall, Firewall B 385. Additionally, the PROCONs 345A through 345S respectively and TPCON 355 may communicate via a separate channel information relating to the overall Key Management System (KMS). The TPCON 355 itself also communicates to Cardholder Data Environment (CDE) 360 within the Trusted Platform 370. Accordingly as depicted there are S PROCONs, R Master Databases, P APIDBs, N APIs, and M APIWebs interfaced between the Trusted Platform 370 and External World 305. Each of S,P,N,M may scale arbitrarily according to the requirements of the system architecture 300 based upon a variety of factors, including but not limited to the loading/requirements of the External World 305, the capabilities of the Trusted Platform 370, and the architecture/performance of each of the software systems and/or software applications in execution upon the software systems. Accordingly, each of S, P, N, M may scale with a different relationship to a particular characteristic of the system architecture 300 such as for example, but not limited to, the volume of financial processing requests per hour or the number of financial instruments stored within the CDE 360. Further the number R Master Databases may not scale linearly with the number S PROCONs. In other embodiments of the invention fixed ratios may be established for S:P:N:M as well as S:R or ratios may established at multiple levels wherein activities relating to the financial processing system supported by the system architecture 300 determine which level of ratio is to be employed between the different architecture elements of the system architecture 300.

According to an embodiment of the invention the processes in execution upon the software system elements within the Internal Environment in FIGS. 2A and 3A may be synchronous whilst those in the External Environment may be asynchronous to the processes within the Internal Environment. This synchronous/asynchronous processing allows requests received from the External World 205 which have no predetermined schedule or sequence to be handled by the Internal Environment which runs processes triggered in dependence upon these external requests, e.g. add new customer credit card data, in parallel to processes triggered by the software application itself, e.g. run billing cycle for subscribers of wireless carrier service in Washington on the first day of every month.

Referring to FIG. 3B there is depicted an exemplary process flow 3000 indicating the load balancing, polling and a firewalled anti-hacking aspects of a system implementing financial transactions according to embodiments of the invention such as described above in respect of FIGS. 2A through 3A respectively. Process flow 3000 being depicted as process arrows between elements of the system such as described above in respect of FIG. 3A. These being External World 3005, APIWeb 3020, APIDB 3040, PROCON 3045, TPCON 3055, and CDE 3060 wherein consideration of which one of the one or more system elements implementing each function has been removed for simplicity. Accordingly, for example APIWeb 3020 may be APIWeb 320X, where X=1, . . . , N; APIDB 3040 may be APIDB 340Y, where Y=1, . . . , P; and PROCON 3045 may be PROCON 345Z, where Z=1, . . . , S.

Accordingly, exemplary process flow 3000 begins with process step 3050 wherein a PROCON 3045 is initialized and thereby communicates to APIDB 3040, this communication including at least a unique identity (UniqueID) of the PROCON 3045 and an acceptable command set that the PROCON 345 is able to process, defined with associated ProcessIDs. Subsequently, a process request is received at APIWeb 3020 from a client of the financial software application in execution upon a financial software system such as described above in respect of system architectures 200 and 300 in FIGS. 2A and 3A respectively. The APIWeb 3020 then sends a request to APIDB 3040 in step 3150 relating to the process request received from the client in step 3100. Optionally, where required the APIWeb 3020 in conjunction with the KMS 325X may encrypt card holder data prior to transmission. In response to the APIWeb 3020 request the APIDB 3040 sends, in step 3200, to the APIWeb 3020 a list of PROCONs 3045 accepting processing requests of the type specified by the client in the External World 3005 which are identified via the unique ProcessIDs provided to the AIPD 3040 by the PROCONs 3045 in step 3050.

Accordingly, the APIWeb 3020 selects a PROCON 3045 from the received list of PROCONs 3045 and transmits in step 3250 to APIDB 3040 a process request, with associated unique ProcessID which identifies the PROCON 3045, together with a unique identity of the request (RequestID). Subsequently in steps 3300 and 3350 a PROCON 3045, when its loading meets a predetermined limit, accesses the APIDB 3040 to establish whether processes having it's ProcessID exist and downloads a predetermined portion of these based upon its current process loading.

PROCON 3045 thereby executes the requested process in conjunction with the received process data which may require additional steps 3400 and 3450 wherein the PROCON 3045 communicates with the TPCON 3055 and/or CDE 3060 as necessary to complete processing of the request from the APIWeb 3020. Once the process is completed the PROCON 3045 transmits in process step 3500 the processed result to the APIDB 3040 together with the ProcessID originating from the APIWeb 3020. Subsequently the requesting APIWeb 3020 pings the APIDB 3040 with the ProcessID in step 3550 to see whether the processed result of the request associated with the ProcessID has been returned by the PROCON 3045 selected by the APIWeb 3020. If a processed result is stored within the APIDB 3040 with a process identity matching the ProcessID established by the initiating APIWeb 3020 then the processed result is transferred from the APIDB 3040 to the APIWeb 3020 in step 3650 and the associated processed result removed from APIDB 3040 as well as having been removed from the PROCON 3045 once transmitted to the APIDB 3040.

If an APIWeb 3020 executes process step 3055 and no response is generated by the APIDB 3040 such that process step 3060 does not occur then the APIWeb 3020 places that process thread into a hold and retries at a predetermined point in time later, for example after a predetermined time has elapsed or after a predetermined number of other process threads initiated to the same PROCON after the paused thread have been completed. If a subsequent predetermined trigger point is reached and the process thread has not been completed then the APIWeb may delete the process thread from its store of pending process threads and send the requesting client a timeout message. It would be apparent that such a deletion of the process thread means that the resulting process response stored within the APIDB 3040 will not be retrieved leaving this as orphan data.

Accordingly, such orphaned process responses may be transferred after a predetermined trigger condition is met, such as the length of time the process response has been held pending by the APIDB 3040 for example, to an Orphan Database (OrphanDB). In the event that the requesting client resends a response relating to a process thread for which they have previously received a timeout response the communications from the External World 3005 to the APIWeb 3020 may include a flag indicating it as a resend which is forwarded to the APIDB 3040 as part of the new process thread wherein the data relating to the requested process thread is parsed and compared to that within the OrphanDB such that a duplicate transaction is terminated at the APIDB 3040. Optionally, all requests received at the APIDB 3040 may be parsed and compared to the contents of the OrphanDB to filter out duplicate requests. The contents of the OrphanDB may be stored together with a hash of the subscriber and financial instrument such that determining the presence of a prior orphaned transaction is determined with increased speed and reduced processing complexity as this hash is now all that is required to be compared to received process requests. OrphanDB may execute aging processes for orphaned responses in order to limit the size of the database and processing overhead for checking for duplicate process requests. Additionally, monitoring of process entries into the OrphanDB may identify issues with APIWebs, PROCONs etc.

Accordingly, the overall process described in respect of process flow 3000 may be synchronous in respect of activities inside the first firewall, Firewall A 380X, and asynchronous in terms of the activities outside the first firewall, Firewall A 380X. It would also be evident that in the event that an attack is made upon an APIWeb, for example APIWeb 320X and 3020 in FIGS. 3A and 3B respectively, that the only information accessible to it from inside the first firewall Firewall A 380X is that currently stored within it and that associated with the completed processes stored upon the APIDB 3040 for which unique identities exist with the APIWeb as they relate to processing triggers requested by the APIWeb.

Optionally, the acceptable command set of each PROCON 3045 may be established in dependence upon a characteristic or characteristics of the software system upon which the PROCON 3045 is initialized. It would be evident that where multiple PROCONs 3045 are active that a first level of load balancing is undertaken in that PROCONs 3045 are allocated processing tasks according to the processing type required by the APIWeb 3020 as derived from the original client request and their selection by the APIWeb 3020 from the set of available PROCONs 3045 provided to it by the APIDB 3040. Accordingly, APIWeb 3020 may be established with a protocol according to one or more load balancing techniques in the prior art such as random choice, round-robin etc with respect to selecting a PROCON 3045. It would be evident that a second level of load balancing may be performed at the APIDB 3040 by selecting sub-sets of available PROCONs 3045 when providing a list of PROCONs 3045 handling a particular process to an APIWeb 3020. Other load balancing may be implemented for example by other elements within the software system according to embodiments of the invention including, but not limited to, PROCONs 3045 directly adjusting communications to the APIDB 3040 such as for example, but not limited to, signaling their current loading, temporarily withdrawing one or more processes from those supported, and temporarily withdrawing their availability for any process requests. Optionally, the PROCONs 3045 may communicate with one another to determine whether one or more of the load balancing mechanisms should be enacted by one or more PROCONs 3045 with the system architecture.

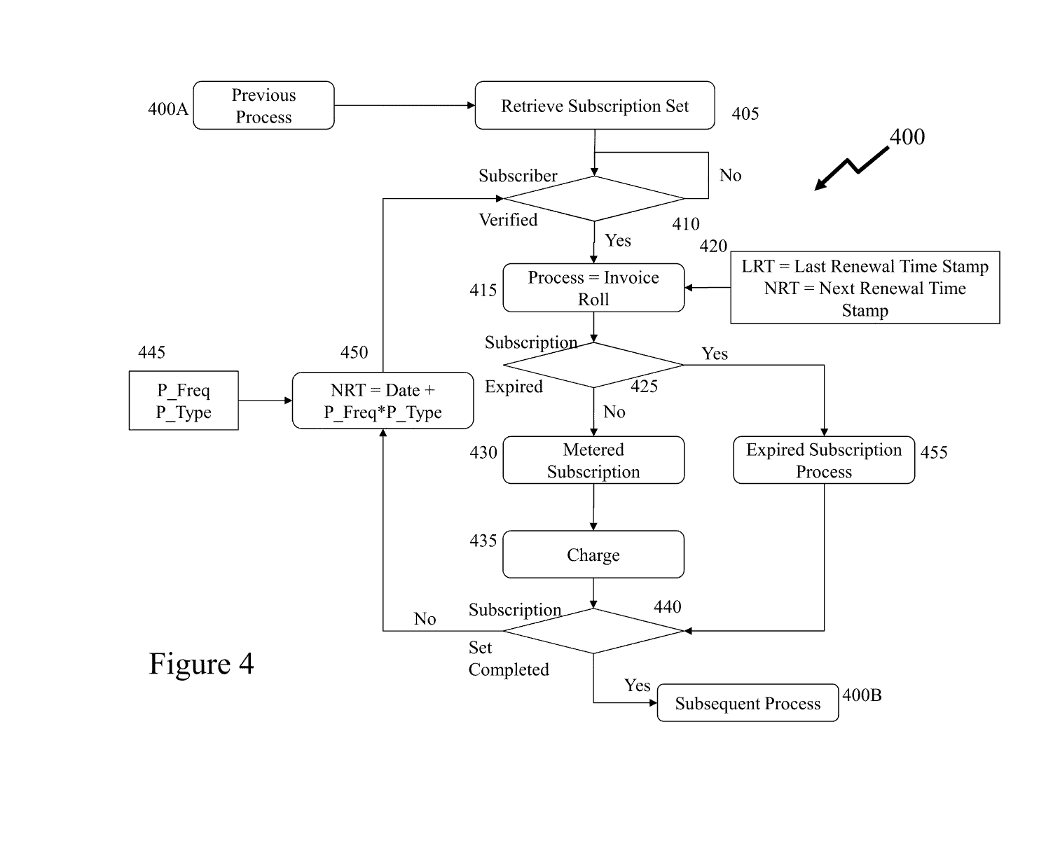

FIG. 4 depicts an exemplary process flow 400 for processing a batch of subscriptions as part of an overall software application according to an embodiment of the invention. The process therefore starts at step 400A with a prior portion of the software application calling the batch subscription process. The process therefore in step 405 retrieves the set of subscriptions to be processed which may be a predetermined portion of an overall database of subscriptions before progressing forward to step 410 wherein a subscriber associated with the first subscription of the set of subscriptions is validated. If the validation fails the process loops to the next subscriber otherwise the process proceeds to step 415 wherein the data for this process, in this instance an invoice roll, is retrieved from the appropriate database, such as CDEs 260 and 360 in FIGS. 2A and 3A respectively. In this exemplary process flow 400 the data retrieved is Last Renewal Time Stamp (LRT) and Next Renewal Time Stamp (NRT) wherein the process proceeds to step 425 to determine whether the subscription for this subscriber has expired. If the determination is positive then the process proceeds to step 455 wherein an expired subscription process is executed and the process proceeds to step 440. Otherwise the process proceeds to step 430 wherein any metered subscription data is calculated for the subscriber, such as for example the subscriber has a monthly cellular subscription giving them a predetermined number of free minutes wherein excess minutes are charged at a predetermined rate, these excess minutes therefore forming part of the metered subscription calculation along with other elements relating to the subscriber account and the client account to whom the subscriber has a subscription. Accordingly having calculated the metered subscription data for the subscriber the process proceeds to step 435 wherein the metered subscription and subscription are charged to the financial instrument of the subscriber they provided to the client when registering their subscription.

From step 435 the process proceeds to step 440 wherein it is determined whether the subscription set being processed has been completed. If yes then the process proceeds to step 400B and subsequent processes of the software application are executed. If not then the process proceeds to step 450 wherein the process calculates the new NRT, NRT=Date+P_Freq×P_Type, wherein P_Freq and P_Type are variables relating to the subscribers subscription extracted by the process from a database, such as CDEs 260 and 360 in FIGS. 2A and 3A respectively, by the process in step 445. From process step 445 the process returns to step 410. According to an embodiment of the invention P_Type=0, 1, 2, 3, 4, 5, 6, and 7 for subscription frequencies defined in terms of:

P_Type=0—frequency=second;

P_Type=1—frequency=minute;

P_Type=2—frequency=hour;

P_Type=3—frequency=day;

P_Type=4—frequency=week;

P_Type=5—frequency=month;

P_Type=6—frequency=quarter; and

P_Type=7—frequency=year, respectively.

According to other embodiments of the invention P_Type may define subscription frequencies established in dependence upon one or more factors including, but not limited to, the ware(s) and/or service provider(s), user preferences, the ware(s), the service(s) and the provider of the Internal Environment as described in respect of FIGS. 2A and 3A respectively. Other P_Type values may be established for simplicity of management with respect to the External World but may be processed internally as another P_Type value. For example, P_Type=29 relates to a frequency of lunar cycles wherein a single cycle of P_Type=29 is internally processed as {P_Freq,P_Type}={29,3}, i.e. 29 days. Whilst P_Type may be an integer in some embodiments of the invention in others it may be free-form, e.g. P_Type=1 defines minutes and P_Type=LUN defines lunar cycle.

According to an embodiment of the invention P_Freq=1, 2, 3, 4, . . . is an integer number defining the number of subscription periods for recurrence of the billing process. However, it would be evident that according to other embodiments of the invention that P_Freq may be any numeric value, e.g. P_Freq=0.5, such that for example an External World system that has legacy systems establishing billing cycles as monthly, and hence automatically as P_Type=5, may provide clients with alternate billing cycles such as weekly or bi-monthly by setting P_Freq=0.25 and P_Freq=0.5 respectively. In contrast, another External World system may support weekly billing cycles and hence {P_Freq, P_Type}={4,1} and {P_Freq,P_Type}={4,2} respectively rather than {P_Freq,P_Type}={5,0.25} and {P_Freq, P_Type}={5,0.5} respectively. In other embodiments of the invention P_Freq may also be alphanumeric to support a wider range of options such that now NRT=Date+FN{P_Freq,P_Type}.

Accordingly, it would be evident that a wide variety of subscription duration types may be handled by an exemplary billing process such as described above in respect of FIG. 4 and process flow 400 with those ranging from per minute plans, such as wireless telecommunication services, to annual or biennial plans for example such as software licenses, magazine subscriptions, etc. Further, other time intervals may be employed including, but not limited to, seconds, bi-monthly, bi-annual, biennial, and triennial for example. Optionally, a financial transaction may be established with P_Freq=0 and P_Type=0 thereby resulting in the software application processing the transaction immediately or automatically upon first instance such that a financial transaction of this form may be applied to a single event, e.g. a purchase. Alternatively, a financial transaction may be processed “immediately” using established with {P_Freq,P_Type}={1,0} or {P_Freq,P_Type}={30,0} setting 1 second and 30 second recurrences or other short durations. It would also be evident that non-traditional subscriptions may be established according to embodiments of the invention such as every 20 days, 2 months, 5 minutes, 4 months, 5 days, 18 months, and 3 years for example.

Optionally, according to another embodiment of the invention a subscription may have multiple P_Freq, P_Type and financial values associated with it such that for example a subscriber may be charged an annual fee and a monthly fee for the same ware and/or service. Alternatively the multiple P_Freq and P_Type may allow billing to be provided as of the current date of executing the billing rather than based upon predetermined periods of time. Accordingly, a billing process run 6 weeks for a subscriber after their previous billing cycle may be charged for 6 weeks even though their contract with the provider is based upon a monthly fee. Similarly, a customer may be charged for a service on a monthly basis and then if they maintain the subscription for a year the process executes the annual charge which based upon their “credited” monthly subscriptions may be negative such that the subscriber receives a discount for maintaining their subscription for the year.

It would also be evident that a user's subscription may be adjusted with ease according to embodiments of an invention. For example, changing a user from a monthly subscription to an annual subscription is simply achieved either by adjusting P_Freq from 1 to 12 or adjusting P_Type from 5 to 7 with an appropriate adjustment in the Date to reflect the change in the user's subscription. It would also be evident that additional recurring billing fields may be specified in addition to P_Freq and P_Type such as, for example, N_Count, N_Run, or End_Date. N_Count and N_Run may, for example, be associated with counters for maximum number of recurring billing cycles to be charged and the number of recurring billing cycles executed to date such that when N_Run≧N_Count the recurring billing process terminates and/or is removed from the databases such that the recurring billing process does not come back into sequence. Similarly, End_Date may specify a latest date for executing a recurring billing process such that irrespective of P_Freq and P_Type the recurring billing process continues until the point that Current_Date≧End_Date in which case the recurring billing process terminates and/or is removed from the databases such that the recurring billing process does not come back into sequence. It would be evident that End_Date may be preferred in some embodiments of the invention as the same End_Date may be associated with multiple billing processes for the same individual product, service, subscriber, such that for example a monthly recurring billing process for a product may be executed simultaneously with a second recurring billing process for daily usage of the product.

Optionally, in process step 435 wherein charging is determined for the subscription charges may be based upon flat rate cost structures or variable pricing structures such as for example tiered volume pricing discounts. Process flow 400 as presented above relates to a billing cycle for subscribers of a client who exploits the software system and software application as described above in respect of FIGS. 1 through 4. Such an exemplary billing cycle may for example be triggered directly by a PROCON, such as PROCONs 245 and 345A through 345S respectively in respect of FIGS. 2A and 3A respectively. Optionally, the process flow 400 may include an additional process step wherein a batch of subscriber accounts are identified and scanned to determine accounts for processing. Such additional subscriber account filtering to that identified within the process flow 400 may for example relate to a particular client of the software system and software application or a predetermined subset of subscribers of the client, such as for example those within a predetermined geographic region or having predetermined characteristics of their accounts.

It would be evident that in some occurrences of recurring billing processes that the recurring billing process may be due for execution upon a date that is not a real date. For example, a customer may make a purchase on the 31^{st} of October with a monthly recurrence where clearly some subsequent recurrences cannot exist as some months only have 30 days and February 28, except leap years. Embodiments of the invention such as for example those exploiting numeric formats for date, such as for example YYYYMMDD (ISO 8601) that a subsequent recurrence will automatically trigger the recurrence associated with the unreal date as CRT≧NRT. Alternatively, the recurring billing process may at the end of a predetermined period, e.g. end of known last day of a month, perform an orphan search for recurring billing accounts which have not been resolved as their recurring billing NRT lies at a CRT greater than the end of the month but less than the start of the next month; e.g. 20131130<NRT<20131201. Other implementations to accomplish the resolution of orphan billing cycles may be evident to one skilled in the art.

Within organizations exploiting recurring billing processes for clients and customers it would be evident that in addition to ensuring customer and/or client billing processes are executed automatically and on time that internally the organizations are required under generally accepted accounting principles (GAAP) such as those associated with tracking the earned credit and/or debt relating to a product and/or service. For example, an organizations financial year end may be March 31 whilst but its clients are billing annually distributed throughout the year. Accordingly, a client billable April 2 has, according to whether billing is for services due to be provided or services provided has a different accrual to a customer billable March 29. Consider, a service billed on service to be provided then the amount of service owing to a customer is simply NRT−CRT where CRT=XXXMarch3235959, i.e. 11:59:59 pm on March 31. Hence, financial reporting data for providing the financial group within the organization to meet their GAAP compliant reporting requirements may be obtained with relatively simple processing from the recurring billing process data.

Optionally, a PROCON may have a maximum batch size of subscriber accounts, for example 2,000; 8,000; 16,000; 64,000; or 500,000 etc. or it may have a batch size for such a process determined in dependence upon characteristics of the software system upon which the PROCON is in execution. Such characteristics including but not limited to available memory, processor loading, and current processes in execution relating to the software system and/or software application. Hence, the batch size may be established as a few, a few tens, a few hundreds, a few thousands or tens, hundreds, millions of subscriber accounts. However, typically a PROCON executing a billing process or another process may be limited to a lower batch size limit such that if a PROCON executing the software system relating to aspects of the software application fails during execution a repetition of the process may be performed quickly and automatically as only a relatively small number of subscriber accounts are impacted. In this manner, re-executing the batch of subscriber accounts, particularly where the number of subscriber records has been determined in dependence of the software system characteristics, may be undertaken without a substantial loading to CPU time of the system upon which the PROCON is in execution.

Hence, PROCONs may be established upon a wide range of computing platforms as the batch size of subscriber accounts is determined for each PROCON based upon its characteristics. Accordingly, a large number of legacy lower cost processor based computing platforms may support billing and subscription services as described within this specification rather than requiring high end, high cost processing systems.

It would be evident that based upon the characteristics of the systems according to embodiments of the invention such as the exemplary billing process described above in respect of FIG. 4 and process flow 400 in conjunction with a plurality of PROCONs 345A to 345S respectively operating in conjunction with one or more PROCON Client Management Systems 380X that subscriber accounts may be processed continuously and in fact a subscriber account may be processed multiple times without a transaction being triggered to the subscriber account as the time of execution, CurrentTime, is such that CurrentTime<NRT<Date+FN{P_Freq,P_Type}.

It would also be evident, that the plurality of Master Databases 350A to 350R may be partitioned based upon the initial P_Type and/or P_Freq or combination thereof. Similarly, PROCONS may be allocated based upon determinations made by the PROCON Client Management Systems 380X in dependence upon data extracted from the plurality of Master Databases 350A to 350R. Accordingly, a subset of PROCONs may be allocated to performing subscriber account processing for P_Type={(0),(0,60)}, for example, associated with subscriber accounts with per second billing and billing frequencies of less than 60 whilst another subset of PROCONs may be processing P_Type={(1), (0,N)}, for example, associated with subscriber accounts with per second billing and billing frequencies of any frequency.

Within the descriptions of the embodiment of the invention described above in respect of FIGS. 1 through 4 respectively a number of encryption keys, referred to as keys, are outlined as being generated by the TPCON within the Trusted Platform such as Trusted Platforms 270 and 370 in FIGS. 2A and 3A respectively. Accordingly, the Trusted Platform may set the number of keys to a predetermined number, for example 256, 512, 750, 1024, 2048, etc. It would be evident to one skilled in the art that the Payment Card Industry (PCI) through the PCI Data Security Standard (PCI-DSS), being an information security standard for organizations that handle cardholder information for the major debit, credit, prepaid, e-purse, ATM, and POS cards, establishes encryption key lifetime, also known as cryptoperiod, as a significant issue and that keys should be periodically removed from active use and replaced with others, a process typically referred to as rolling keys as the sub-set of active keys may be viewed as rolling across the available overall key set as keys are added and removed from active use.

Accordingly, the KMS within each APIWeb within the key store maintains for example four entries for each key:
Key_Value the key code itself, for example 192-bit 3DES, 128-bit AES, 192-bit AES, 256-bit AES encryption as well as others including, but not limited to Twofish, Serpent, AES (Rijndael), Blowfish, CASTS, RC4, 3DES, and IDEA;
Key_ID the unique identity associated with the Key_Value by the KMS such that transmittal of the Key_ID back to the Trusted Platform is sufficient for the Trusted Platform to select the appropriate key to decrypt the information transmitted to it;
Key_Use_Count a counter indicating how many times the specific Key_Value has been used and may be employed to determine when to delete the encryption key irrespective of whether a predetermined temporal trigger point has been reached; and
Key_Date_Time a date and time associated with the specific Key_Value indicating when the encryption key should be deleted irrespective of how many times it has been used.

Accordingly an encryption key transferred from the Trusted Platform to a Key Store of an API as part of a key set may be employed by the APIWeb to encrypt information and aged based upon either use or time based criteria. As the keys within the key set of an API are aged/deleted then a trigger threshold may be established at which point the API requests an additional key set to increase the number of available keys. Within the embodiments of the invention described above in respect of FIGS. 1 through 4 then an encryption key set is established by the TPCON within the Trusted Platform. Whilst only a single TPCON, namely TPCONs 255 and 355 in FIGS. 2A and 3A, is depicted within the Trusted Platforms 270 and 370 in FIGS. 2A and 3A respectively multiple TPCONs may be associated with a CDE. In this instance each TPCON still generates its own key set, which will be transmitted to the APIWebs, and associated unique identities for each key within the key set but these are also communicated to the CDE to ensure that there are no duplications within the multiple key sets of the TPCONs.

As requests are processed by an APIWeb using a key from the local key set within the Key Store of the API then an API may establish one or more policies with respect to keys that may be based upon factors including, but not limited to, time, date, client identity, user identity, subscriber identity, PROCON to process request, and type of process requested. It would be evident that such a key management system and associated policies may be further extended such that multiple key sets are employed simultaneously wherein different encryption methodologies are employed in dependent upon one or more factors such as those identified previously as well as others such as financial instrument to which process relates and monetary value of the transaction to which the request relates for example.

It would be evident to one skilled in the art that the CDE holds highly sensitive data relating to subscribers, clients, customers, etc. Accordingly, the CDE, as depicted in FIGS. 2A and 3A by CDEs 260 and 360 respectively, and Master Database, as depicted in FIGS. 2A and 3A by Master Databases 250 and 350A through 350R, are disassociated such that an attack upon a Master Database behind the first firewall does not compromise the contents of the CDE behind the first and second firewalls. For example, each customer is given a customer identity, CUST_CDE_ID which is randomly generated by the software application in execution upon the Master Database, such as for example CUST_CDE_ID=RND(Seed) wherein Seed is a seed used in the initialization of a random number generator. Accordingly, a process request relating to a new customer triggers the PROCON handling the request to acquire a new CUST_CDE_ID from the Master Database associated with the PROCON which is transmitted back to the requesting client.

However, this CUST_CDE_ID is not communicated to the CDE by the TPCON within the Trusted Platform communicating with the PROCON generating this CUST_CDE_ID from its Master Database. Rather the TPCON hashes three values in order to generate an identity for the CDE, CDE_ID. These being:
CUST_ID this is the account number associated with the subscriber established by the provider of the subscription to the subscriber;
CUST_CDE_ID this being the Customer_ID generated by the Master Database associated with the PROCON processing the request and communicating it to the TPCON; and
ACCT_ID this is the account number associated with the software system and software application for the provider of the subscription to subscribers.

Accordingly, this hash is stored together with the encrypted financial instrument data the unique identity, SSK_ID, generated by the TPCON with the encryption key used to encrypt the financial instrument data. Only with all three items and the encryption key associated with the SSK_ID can an attacker seeking data from the CDE obtain any sensitive data.

As described above a predetermined number of encryption keys SSK are established by each TPCON, for example 1024 keys, which are denoted as SSK_{X-1024} where X=1, . . . , 1024. These encryption keys SSK_{X-1024} are encrypted with a Master Key generated from a pair of Master Keys, MK₁ and MK₂, which are combined to form the encrypting Master Key, MK. The resulting encrypted encryption key provides the unique identity of each encryption key SSK_ID_{X-1024}. Accordingly SSK_ID_{X-1024} MK\textcircled{×}SSK_{X-1024}=(M₁\textcircled{×}M₂)\textcircled{×}SSK_{X-1024}, wherein \textcircled{×} denotes a hash process. Hence, when a TPCON receives an SSK_ID_{X-1024}, it knows MK and hence the encryption key SSK_{X-1024} can be determined. However, any external attacker intercepting signals between the Trusted Platform and other elements of the software system will only receive encrypted content and SSK_ID_{X-1024} which would not allow them to establish the SSK_{X-1024}. It would be evident to one skilled in the art that the customer/subscriber data stored upon the CDE decrypted with the SSK_{X-1024} from the APIWeb may be stored in encrypted form by encrypting it with the two Master Keys, MK₁ and MK₂.

A TPCON within a Trusted Platform may under an embodiment of the invention be logged onto the software system by providing it with a pair of Master Keys, MK₁ and MK₂. According to another embodiment of the invention a known answer test can be performed on SSK₀ with MK₁: MK₂ which allows either MK₁ or MK₂ to be changed without requiring the entire database within the CDE be re-written/re-encrypted with the new security key. Accordingly, a Master Key may be replaced in the event, for example, that there is suspicion of a breach of security compromising the Master Key or that a policy exists to automatically replace periodically the Master Keys within the Trusted Platform.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
storing subscriber data within a database forming a predetermined portion of a trusted platform connected to a network, the subscriber data relating to a plurality of subscribers and comprising for each subscriber of the plurality of subscribers at least a financial instrument, a subscription duration type, a subscription frequency, and a next renewal time;
executing upon a process controller connected to the network and comprising at least a microprocessor a billing process, the billing process relating to a plurality of subscribers for whom subscriber data is stored upon the database;
determining for each subscriber of the plurality of subscribers whether a subscription billing event is due in dependence upon at least the current time and the next renewal time;
calculating a new next renewal time for each subscriber of the plurality of subscribers when the determination is positive, the new next renewal time calculated in dependence upon at least the subscription duration type and subscription frequency of the subscriber of the plurality of subscribers; and
storing for each subscriber of the plurality of subscribers when the determination is positive the new next renewal time within the subscriber database.

2. The method according to claim 1, wherein
the billing process execution on the process controller is established by a subscriber client management system; and
the subscriber client management system establishes billing process execution upon a plurality of process controllers.

3. The method according to claim 1, wherein
execution of the billing process on the process controller is independent of the subscription duration type, the subscription frequency, and the next renewal time.

4. The method according to claim 1, wherein
execution of the billing process for the plurality of subscribers is not linked to an anniversary date of a subscription to which the subscription duration type,

5. The method according to claim 1, wherein
execution of the billing process on the process controller for the plurality of subscribers is automatically triggered when a predetermined portion of the total number of subscribers whose subscriber data is stored within the database.

6. The method according to claim 1, further comprising;
generating a charge relating to each subscriber of the predetermined subset of the plurality of subscribers when the determination is positive.

7. The method according to claim 1, further comprising;
generating a charge relating to each subscriber of the predetermined subset of the plurality of subscribers when the determination is positive; wherein
the charge generated relates to the period of time between the generation of a preceding charge and the current time.

8. The method according to claim 1, wherein,
each subscription comprises a plurality of subscription types, each subscription type having an associated first value for the subscription frequency, an associated second value for the next renewal time, and a subscription charge.

9. The method according to claim 1, wherein
the process controller is one of a plurality of process controllers, the plurality of process controllers operating asynchronously with respect to each other.

10. A device comprising;
a memory for storing subscriber data within a database forming a predetermined portion of a trusted platform connected to a network, the subscriber data relating to a plurality of subscribers and comprising for each subscriber of the plurality of subscribers at least a financial instrument, a subscription duration type, a subscription frequency, and a next renewal time; and
a process controller connected to the network and comprising at least a microprocessor, the process controller storing within a non-volatile non-transitory memory instructions for a process for execution by the processor, the process comprising the steps of:
executing a billing process, the billing process relating to a predetermined subset of the plurality of subscribers for whom subscriber data is stored upon the database;
determining for each subscriber of the plurality of subscribers whether a subscription billing event is due in dependence upon at least the current time and the next renewal time;
calculating a new next renewal time for each subscriber of the plurality of subscribers when the determination is positive, the new next renewal time calculated in dependence upon at least the subscription duration type and subscription frequency of the subscriber of the plurality of subscribers; and
storing for each subscriber of the plurality of subscribers when the determination is positive the new next renewal time within the subscriber database.

11. The device according to claim 10, wherein
the billing process execution on the process controller is established by a subscriber client management system; and
the subscriber client management system establishes billing process execution upon a plurality of process controllers.

12. The device according to claim 10, wherein
execution of the billing process on the process controller is independent of the subscription duration type, the subscription frequency, and the next renewal time.

13. The device according to claim 10, wherein
execution of the billing process for the plurality of subscribers is not linked to an anniversary date of a subscription to which the subscription duration type,

14. The device according to claim 10, wherein
execution of the billing process on the process controller for the plurality of subscribers is automatically triggered when a predetermined portion of the total number of subscribers whose subscriber data is stored within the database.

15. The device according to claim 10, further comprising;
generating a charge relating to each subscriber of the predetermined subset of the plurality of subscribers when the determination is positive.

16. The device according to claim 10, further comprising;
generating a charge relating to each subscriber of the predetermined subset of the plurality of subscribers when the determination is positive; wherein
the charge generated relates to the period of time between the generation of a preceding charge and the current time.

17. The device according to claim 10, wherein,
each subscription comprises a plurality of subscription types, each subscription type having an associated first value for the subscription frequency, an associated second value for the next renewal time, and a subscription charge.

18. The device according to claim 10, wherein
the process controller is one of a plurality of process controllers, the plurality of process controllers operating asynchronously with respect to each other.
